(19) United States
(12) Patent Application Publication
(10) Pub. No.: US 2012/0281011 A1
(43) Pub. Date: Nov. 8, 2012

(54) METHOD OF DISPLAYING TEXT IN A TEXT EDITOR

(76) Inventor: Oliver Reichenstein, Zurich (CH)

(21) Appl. No.: 13/414,623

(22) Filed: Mar. 7, 2012

Related U.S. Application Data
(60) Provisional application No. 61/450,029, filed on Mar. 7, 2011.

(51) Int. Cl. G09G 5/10

(52) U.S. Cl. 345/596

(57) ABSTRACT

One embodiment of the invention is a method of displaying text in a text editor that can include: displaying a text input region within a background; receiving a keystroke for a first alphanumeric character of a first text line; displaying the first text line in a focus format of a first contrast with the background; receiving a keystroke for a second alphanumeric character of a second text line; displaying the second text line in the focus format; shifting the first text line to a shadow format of a second contrast with the background less than the first contrast when the second text line is displayed in the focus format; and shifting the first text line to the focus format and the second text line to the shadow format when a text input caret shifts from the second text line to the first text line.

### CROSS-REFERENCE TO RELATED APPLICATIONS

The present application claims priority to U.S. Provisional Patent Application Ser. No. 61/450,029, entitled “Method for Focusing Document Input” and filed on 7 Mar. 2011, the entirety of which is incorporated herein by this reference.

### TECHNICAL FIELD

The present invention relates generally to the text editor and word processing field, and more specifically to a system and method of displaying text in a text editor.

### BACKGROUND

Text editors and word processors are ubiquitous in the field of electronic devices. New features are continually added to such text-based composition applications, from new typefaces and spellcheckers to commenting and reviewing functions. However, these additional features often serve to distract a user from composition rather than to aid the user in capturing a concept or idea in text. Furthermore, these text editors fail to direct the focus of a user toward composition and away from simultaneous editing, which often slows composition and reduces user efficiency and throughput.

Therefore, there is a need in the text editor field for a new and improved method of displaying text in a text editor in the text editor field.

### BRIEF DESCRIPTION OF THE FIGURES

FIG. 1 is a flowchart representation of a method of the first preferred embodiment of the invention;

FIG. 2 is a flowchart representation of a variation of the method of the first preferred embodiment;

FIG. 3 is a flowchart representation of a method of the second preferred embodiment of the invention;

FIG. 4 is a flowchart representation of a variation of the method of the second preferred embodiment;

FIG. 5 is a flowchart representation of a method of the third preferred embodiment of the invention;

FIG. 6 is a schematic representation of receiving keystrokes of the methods of the preferred embodiments;

FIG. 7 is a schematic representation of centering the present text line in the text input region of a variation of the methods of the preferred embodiments;

FIGS. 8A and 8B are schematic representations of formatting identifier characters in a variation of the methods of the preferred embodiments; and

FIG. 9 is a schematic representation of shifting the format of text lines according to movement of the text input caret within the text input region of the methods of the preferred embodiments.

### DESCRIPTION OF THE PREFERRED EMBODIMENTS

The following description of preferred embodiments of the invention is not intended to limit the invention to these preferred embodiments, but rather to enable any person skilled in the art to make and use this invention.

### 1. The First Preferred Method

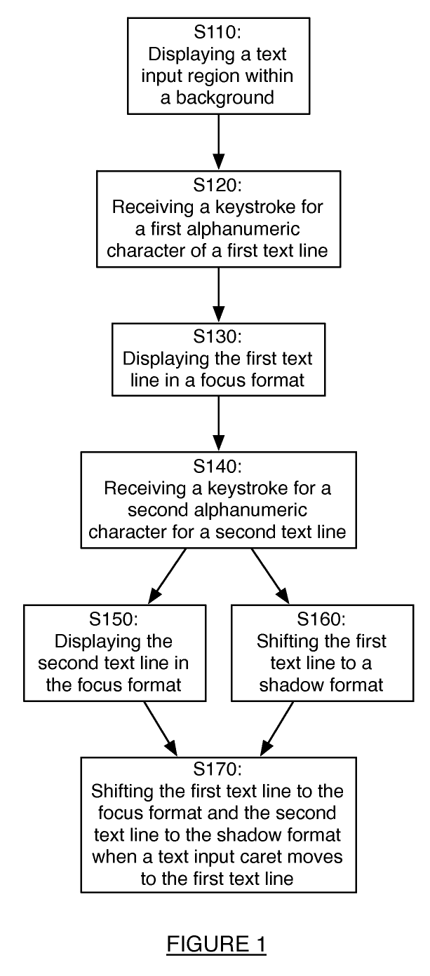

As shown in FIG. 1, a first preferred method of displaying text in a text editor can include: displaying a text input region within a background in block S110; receiving a keystroke for a first alphanumeric character of a first text line in block S120; displaying the first text line in a focus format of a first contrast with the background in block S130; receiving a keystroke for a second alphanumeric character of a second text line in block S140; displaying the second text line in the focus format in block S150; shifting the first text line to a shadow format of a second contrast with the background less than the first contrast when the second text line is displayed in the focus format in block S160; and shifting the first text line to the focus format and the second text line to the shadow format when a text input caret moves from the second text line to the first text line in block S170. The first preferred method generally functions to provide a reduced-distraction writing environment, wherein text lines are presented to a user in varying formats configured to focus the attention of the user on the present text line and reduce distraction caused by peripheral or adjacent text lines. By focusing the attention of the user on the present text line, the first preferred method further relieves the user of an inclination to review and edit previous text lines while drafting the present text line. This provides the benefit of increasing user productivity, as composition of text and editing of text are separated through focused text input.

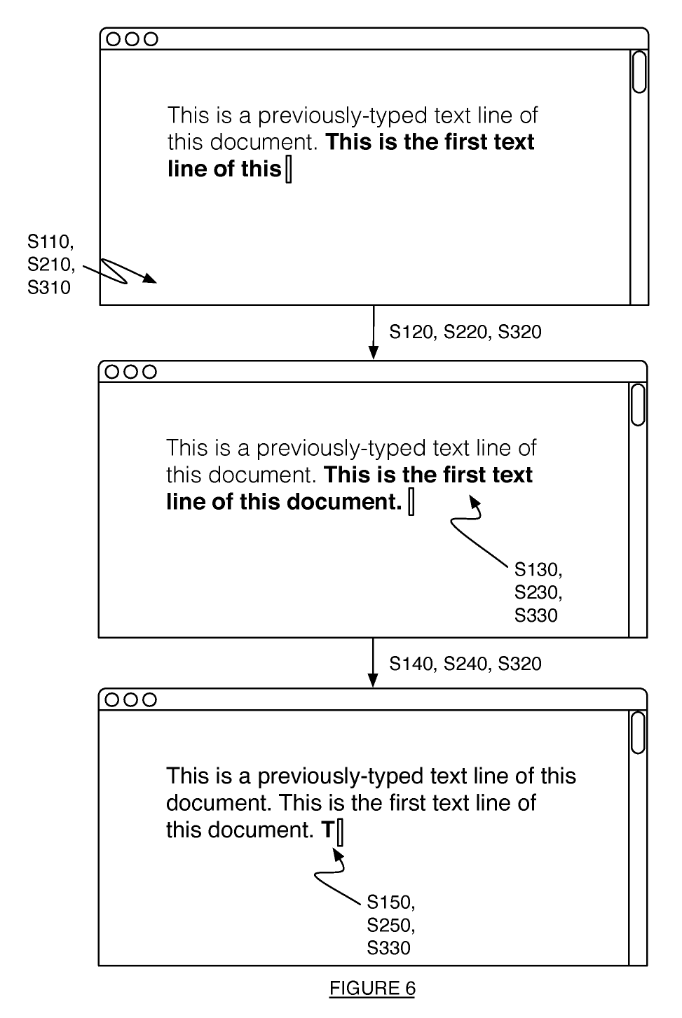

As shown in FIG. 1, block S110 of the first preferred method recites displaying the text input region within the background. Block S110 preferably functions to define an area within a text editor interface in which keystrokes are displayed, on top of and/or within the background, in the form of alphanumeric characters. The background is preferably a plain, solid-color background within the text input region (or text editor window), such as a solid-white background, as shown in FIG. 6. However, the background may be of any other form, pattern, or color.

As shown in FIG. 1, block S120 and block S140 of the first preferred method include receiving keystrokes for the first alphanumeric character of the first text line and the second alphanumeric character of the second text line, respectively. Blocks S120 and S140 preferably function to capture text inputs provided by the user. Suitable inputs can be received through any of a keyboard, touch screen, voice command input module, or any other suitable device or modality connectable to the display on which the text is presented. Preferably, the first alphanumeric character can define the beginning or end of the first text line or any character there between. Similarly, the second alphanumeric character preferably defines the beginning or end of the second text line or any character there between.

In one variation, of the first preferred method a text line (the first, second, third, or any other text line) can include and/or is defined by a string of characters of a predetermined length, such as a maximum number of 64 characters. In another variation of the first preferred method, the text line can include and/or is defined by a predetermined number of words, such as sixteen words. Preferably, a word can include one or more adjacent alphanumeric characters preceded by a space and succeeded by a space or punctuation other than a dash (“—”). In another variation of the first preferred method, the text line can include a sentence. Preferably, a sentence is defined as and/or can include a string of one or more words, the first of which begins with a capital letter and the last of which is succeeded by sentence completion punctuation character (e.g., “.,” “!,” or “?”). In another variation of the preferred method, the text line can include a paragraph. Preferably wherein a paragraph is defined as and/or includes one or more sentences preceded by a line return and succeeded by a line return. In another variation of the preferred method, the text line can include a list (or line) item, defined as and/or including one or more words preceded by a bullet, number, marker, or other symbol and succeeded by a line return. Alternatively, the text line can be of any other form or format or any other suitable grammatical or semantic character, string of characters, modes, modalities, and the like. Furthermore, a suitable text line can be varied in response to user input and/or the editing process, document size, document scope, or any other suitable metric. As an example, sentences can be converted to a paragraph with the deletion/creation of a line return, at which time the text line can be adjusted to include the new entity (paragraph) in favor of the prior entity (sentence). Suitable text lines can also vary between languages, including both natural human languages and computer-readable and/or computer programmable languages.

As shown in FIG. 1, block S130 of the first preferred method can include displaying the first text line in the focus format of a first contrast with the background. Block S130 preferably functions to present the first text line over the background and in a format readily distinguishable from the background and the shadow format. The focus format is preferably a typeface, font size, color, shading, opacity, saturation, brightness, sharpness, or other text-appropriate formatting contrasting with the background substantially more than the shadow format. For example, in the variation in which the background is a plain white background, the focus format may be black, wherein the first text line is displayed over the background in black typeface (e.g., Courier) of a particular size (e.g., 14 pt). The shadow format may thus be a shade of gray and the same typeface and font size as the focus format. Additionally or alternatively the focus format may be bold typeface and the shadow format a normal typeface (as shown in FIG. 6) or the focus format may be a first font size and the shadow format a second font size smaller than the first font size. In another alternative or additional embodiment, the focus format may be a first typeface and the shadow format a second typeface or the focus format can include underlining and the shadow format strikethroughs. In still another alternative or additional embodiment, the focus format may include highlighting and the shadow format no highlighting, or vice versa. In another alternative or additional embodiment, the focus format may include crisp typeface edges and the shadow format may include blurred text and/or the focus format may include any other suitable formatting contrasting more with the background than the shadow format.

As shown in FIG. 1, block S150 of the first preferred method recites displaying the second text line in the focus format. Block S150 preferably functions to present the second text line over the background and in a format readily distinguishable from the background and the shadow format. Block S150 is preferably implemented following initiation of the second text line, as indicated by fulfillment of the number of predetermined characters or words in the first text line or by completion of the sentence, paragraph, or list item of the first text line.

As shown in FIG. 1, block S160 of the first preferred method recites shifting the first text line to the shadow format. Block S160 preferably functions to reduce the contrast between the first text line and the background, as compared to the contrast between the present (e.g., second) text line and the background. Block S160 is preferably implemented following initiation of the second text line, and the format of the first text line may be changed, refreshed, set, reset, altered, adjusted, modified, updated, or shifted from the focus format to the shadow format in Block S160. Specifically, an alphanumeric character beginning the second text line preferably signals transition of the first text line from the focus format to the shadow format such that the second text line preferably thus assumes the focus format. Given the beginning of the second text line, transition of the first text line from the focus format to the shadow format may occur substantially instantaneously, after a time delay, or gradually over a period of time. This transition may yield the benefit of shifting the attention of the user from the first text line to the present second text line, thus reducing potential distraction away from the present text line as may result from the first text line retaining the same visual weight within the text editor as the present text line.

In the first preferred method, the first text line is preferably displayed in the shadow format when the second text line is displayed in the focus format. Furthermore, the first and second text lines are preferably displayed in the shadow format when any other text line is displayed in the focus format as shown in block S170 in FIG. 1. The focus and shadow formats may also define a portion of a format gradient wherein the present text line is displayed in the focus format, a previous text line adjacent the present text line is displayed in a first shadow format of less contrast with the background than the focus format, and/or a second previous text line preceding and adjacent the previous text line is displayed in a second shadow format of less contrast with the background than the first shadow format. For example, the background can be a plain white (hex triplet #FFFFFF) background, the focus format can be black (hex triplet #000000), the first shadow format can be dim gray (hex triplet #696969), and the second shadow format can be light gray (hex triplet #DCDCDC). However, the focus, shadow, and other formats can readily include any other formatting, style, or color.

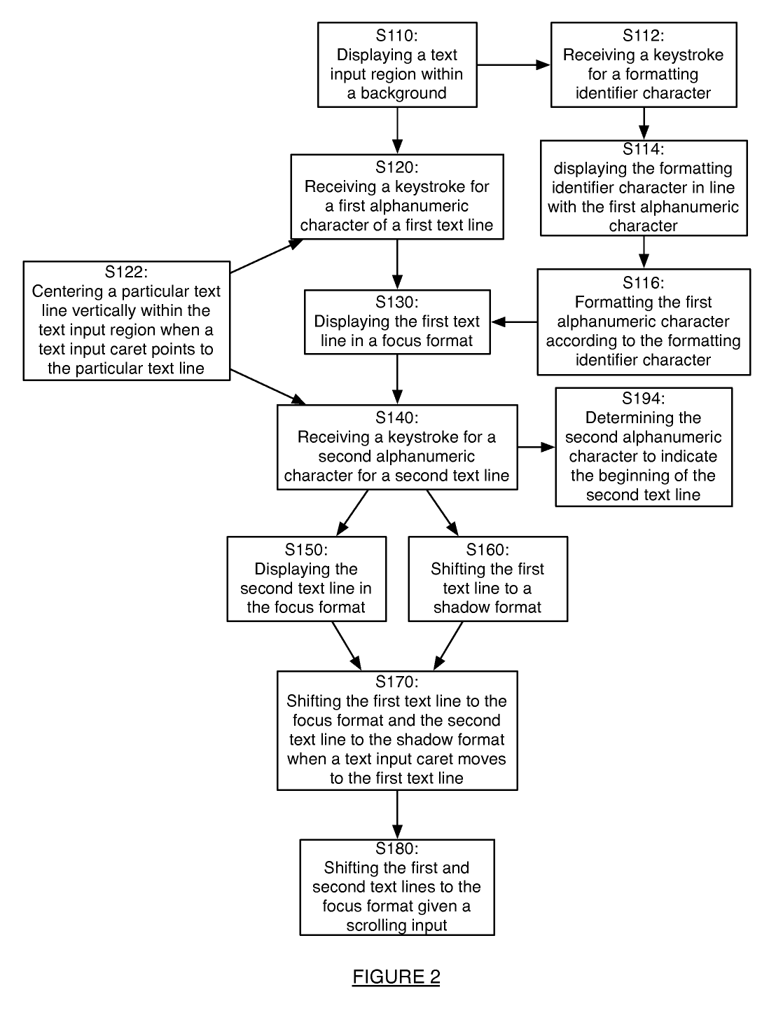

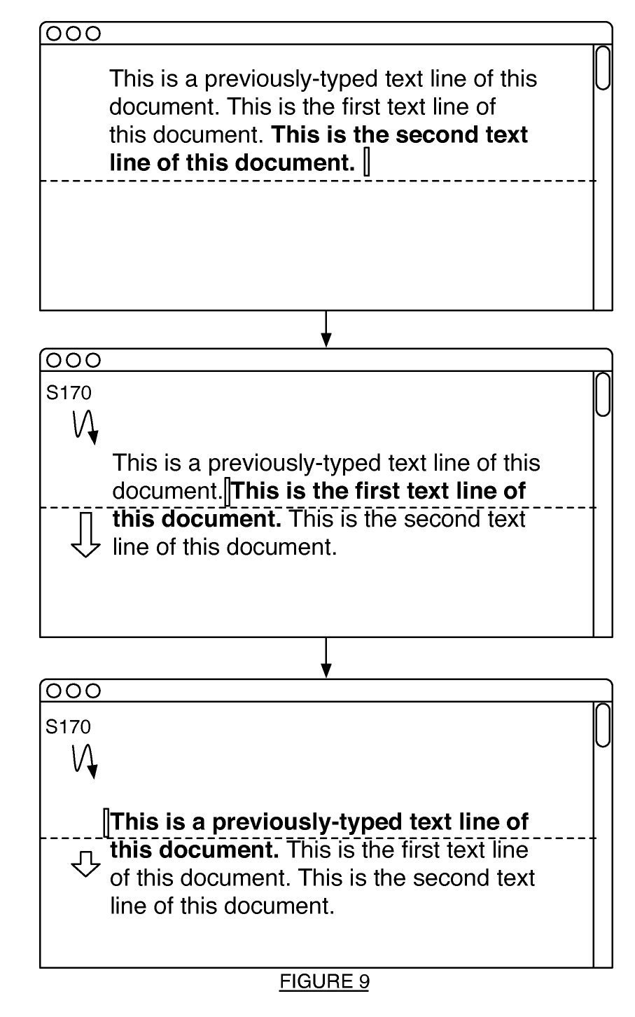

As shown in FIG. 1, the first preferred method can include block S170, which recites shifting the first text line to the focus format and the second text line to the shadow format when a text input caret shifts from the second text line to the first text line. Block S170 preferably functions to shift focus within the text editor based upon an input from the user. During composition of text within the text editor, the user may complete all or portions of the first and second (and other) text lines in sequence; however, the user may also move through previous text lines, such as to edit, review, or reference preceding portions. The user may navigate through text within the text editor via arrow keys of a keyboard, via a mouse cursor, by touching a portion of the text viewed through a touch display, or by any other suitable input, method, or device. Preferably, the focus and shadow formats of text lines within the text editor are preferably updated in Block S170 to reflect the location of a cursor or text input caret within the text editor, as shown in FIG. 9. Specifically, in Block S170, the text line in which the text input caret is arranged preferably becomes the present text line and is updated to the focus format while a portion or all of the other text lines are preferably transitioned to the shadow format. As shown in FIG. 2, one variation of the first preferred method can include Block S194, which recites determining the second alphanumeric character to indicate the beginning of the second text line. In this variation of the first preferred method, a sentence completion punctuation character, such as a “.,” “!,” or “?,” may indicate the end of the first text line. Additionally, the second alphanumeric character that is a capitalized character and is separated from the sentence completion punctuation character by a space may thus signal the beginning of the second text line. This initiation of the second line preferably catalyzes the transition of the first text line from the focus format to the shadow format, and the second text line thus becomes the present text line and assumes the focus format.

As shown in FIG. 2, another variation of the preferred method can include block S180, which recites shifting the first and second text lines to the focus format given a scrolling input. The user may engage a scrolling input, such as through a mouse or trackpad, to move through text in the text editor window. To ease navigation through the text, a portion or all of the text is preferably displayed in the focus format (or the shadow format) until the user selects a particular text line by inserting the text input caret within the particular text line. Once the particular text line is selected, the particular text line preferably becomes the present text line and all other text lines preferably shift to the shadow format. However, document navigation may be aided in any other way.

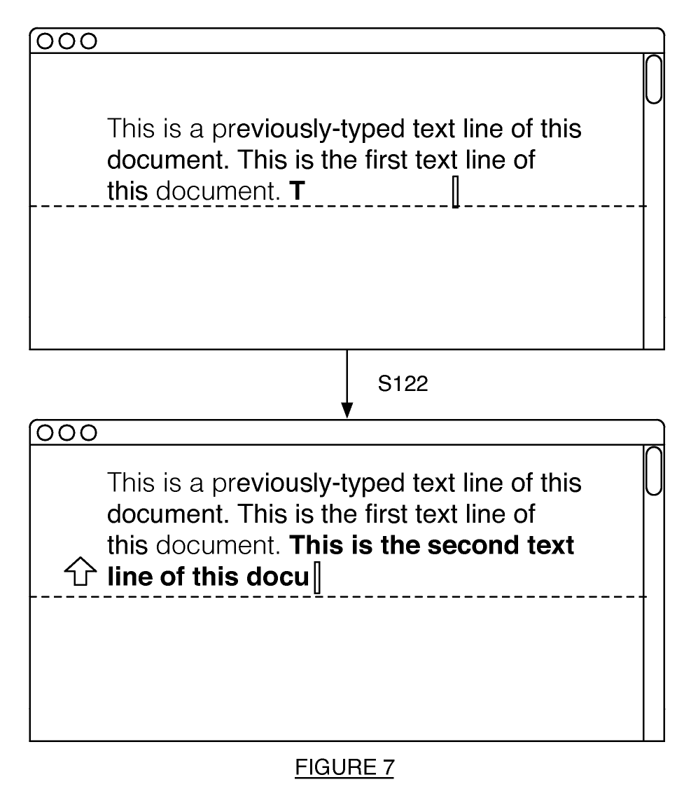

As shown in FIGS. 2 and 7, another variation of the first preferred method can include block S122, which recites centering a particular text line vertically with the text input region when the text input caret (e.g., cursor) points to the particular text line. The particular text line may be centered vertically within the text input region based upon the location of the cursor within the text editor window, based upon the beginning of the particular text line, based upon the vertical center of the particular text line, or based upon any other suitable factor. Buffer blank (white) space may be added before and/or after the present text line to maintain the present text line substantially near the center of the text input region. Block S122 preferably focuses the attention of the user substantially toward the vertical center of the text input region and away from the periphery of the text input region; this may yield the benefit of reducing user distraction since distracting elements, such as other application windows, notifications, pop-ups, and icons may be displayed near the periphery of the text input region and otherwise compete for the attention of the user. Additionally or alternatively, block S122 may reduce the necessity of the user to adjust the vertical location of text within the text editor window during composition, which may also improve throughput as the user may compose uninterrupted by changes in viewing needs. However, Block S122 may function in any other way and yield any other benefit.

As shown in FIG. 2, the first preferred method can further include one or more of: receiving a keystroke for a formatting identifier character in block S112; displaying the formatting identifier character in line with the first alphanumeric character in block S114; and/or formatting the first alphanumeric character according to the formatting identifier character in block S116. Blocks S112, S114, and S116 preferably provide formatting functionality through character-based formatting symbols, which may yield reduced user distraction as core formatting functionality is provided through the same input means as text composition. Specifically, by formatting a portion of a text line based upon characters or symbols provided through keystrokes rather than based upon formatting selections provided through navigable menus or windows (i.e. with a mouse cursor), the user may add, remove, or modify formatting in the midst of composition and specifically without switching to a different input format (e.g., from a keyboard to a mouse).

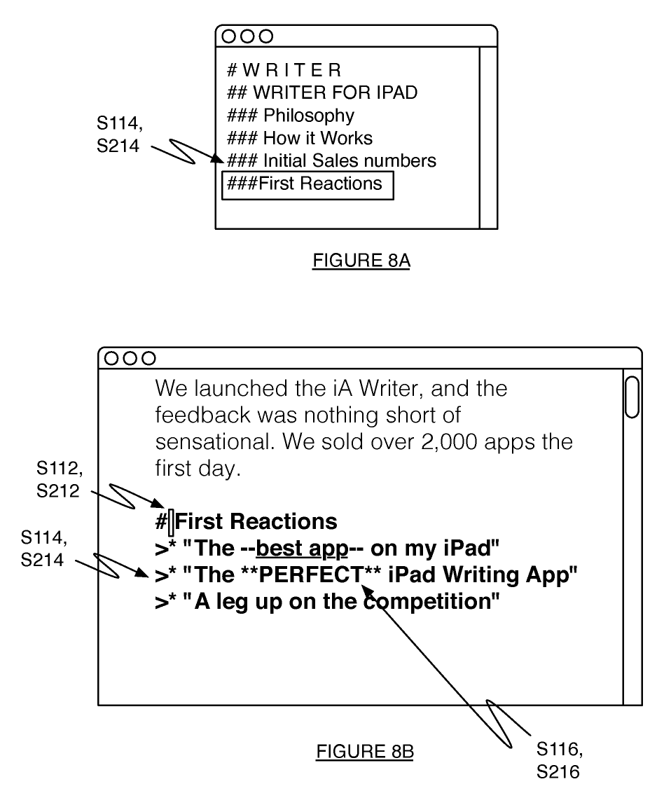

The formatting identifier character is preferably displayed inline with the character, word, or text line so modified. As shown in FIG. 8A, the formatting identifier character may indicate an indent, a heading hierarchy, a bulleted or numbered list, or any other suitable formatting; in this variation, the formatting identifier character preferably precedes the alphanumeric character or text line so modified. Alternatively and as shown in FIG. 8B, the formatting identifier character may be paired with a second formatting identifier character, wherein alphanumeric characters displayed between the formatting identifier character and the second formatting identifier character are modified according thereto. The paired formatting identifier characters may thus indicate bold typeface, an underline, italics, a strikethrough, or any other suitable formatting.

The first preferred method is preferably implemented through a digital text editor executing on an electronic device; keystrokes for alphanumeric characters are preferably captured through a keyboard or keypad coupled to the electronic device; and the alphanumeric characters and text lines are preferably displayed through a digital display coupled to the electronic device. The electronic device may be any of: a laptop, desktop, or tablet computer; a smartphone; a cellular phone; a personal data assistant (PDA); an e-book reader; or any other suitable electronic device. The keyboard or keypad may be a physical keyboard wired to, integrated into, or wirelessly coupled to the electronic device; alternatively, the electronic device may incorporate a touch display, wherein a keyboard or keypad is depicted on a display of the electronic device and keystrokes on the keyboard or keypad are captured via a touch sensor coupled to the display. The text editor may be a local application (“app”) or program executing on the electronic device. Alternatively, the text editor can be a remote or distributed software service that is accessible through a web browser (e.g., a cloud-based service), an email application, or through any other suitable application or program.

### 2. The Second Preferred Method

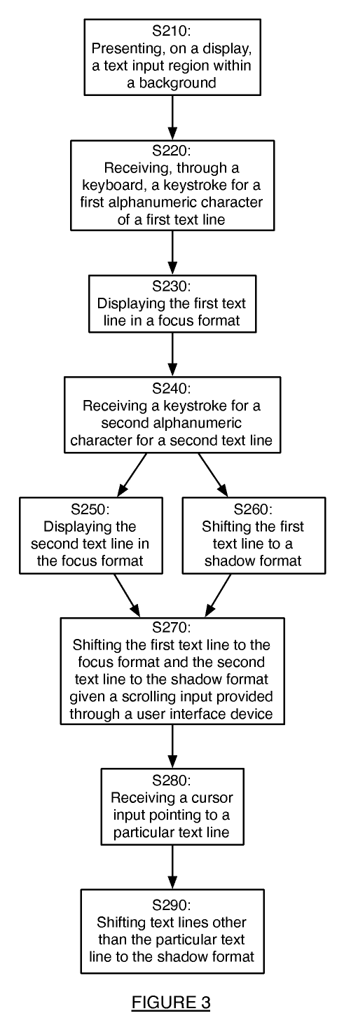

As shown in FIG. 3, a second preferred method can include: presenting, on a display, a text input region within a background in block S210; receiving, through a keyboard coupled to the display, a keystroke for a first alphanumeric character of a first text line in block S220; displaying the first text line in a focus format of a first contrast with the background in block S230; receiving a keystroke for a second alphanumeric character of a second text line in block S240; displaying the second text line in the focus format in block S250; shifting the first text line to a shadow format of a second contrast with the background less than the first contrast when the second text line is displayed in the focus format in block S260; shifting the first and second text lines to the focus format given a scrolling input provided through a user interface device coupled to the display in block S270; receiving a cursor input, through the user interface device, pointing to a particular text line in block S280; and shifting text lines other than the particular text line to the shadow format block S290. The second preferred method functions to provide a reduced-distraction writing environment, wherein text lines are presented to a user in varying formats configured to focus the attention of the user on the present text line and reduce distraction caused by peripheral or adjacent text lines. The second preferred method is preferably implemented by or through a digital text editor executing on an electronic device.

As shown in FIG. 3, the second preferred method can include block S210, which recites presenting, on a display, the text input region within the background. Block S210 preferably functions to define an area within a text editor interface in which keystrokes are displayed, on top of the background, in the form of alphanumeric characters. The background is preferably a plain, solid-color background within the text editor window, such as a solid-white background, as shown in FIG. 6. However, the background may be of any other form, pattern, or color. The background is preferably presented through a digital display coupled to the electronic device. A preferred electronic device can include any of a laptop, desktop, or tablet computer, a smartphone, a cellular phone, a personal data assistant (PDA), an e-book reader, or any other suitable electronic device incorporating a digital display. The digital display may be any of an LED, OLED, LCD, Plasma, segment, e-ink, or other suitable type of digital display. The display may also incorporate a touch sensor for operation of a touch display.

As shown in FIG. 3, the second preferred method can also include block S220 and block S240, which recite receiving, through a keyboard coupled to the display, keystrokes for the first alphanumeric character of the first text line and the second alphanumeric character of the second text line, respectively. Blocks S220 and S240 function to capture text inputs provided by the user. The first alphanumeric character can define the beginning or end of the first text line, or any character there between. The second alphanumeric character can define the beginning or end of the second text line, or any character there between. Keystrokes for the alphanumeric characters are preferably captured through a keyboard or keypad coupled to the electronic device. The keyboard or keypad may be a physical keyboard wired to, integrated into, or wirelessly coupled to the electronic device, or the electronic device may incorporate a touch display, wherein a keyboard or keypad is depicted on a display of the electronic device and keystrokes on the keyboard or keypad are captured via a touch sensor coupled to the display. Preferably, the first, second, and any other text lines can include any of: a string of characters of a predetermined length, a predetermined number of words, a sentence, a paragraph, a list (or line) item, and/or any other suitable grammatical or semantic notation, character, modality in any suitable language as noted above.

As shown in FIG. 3, the second preferred method can further include block S230, which recites displaying the first text line in the focus format of a first contrast with the background. Block S230 functions to present the first text line over the background and in a format readily distinguishable from the background and the shadow format. The focus format is preferably a typeface, font size, color, shading, or other text-appropriate formatting contrasting with the background substantially more than the shadow format. For example, in the variation in which the background is a plain white background, the focus format may be black, wherein the present text line is displayed over the background in black typeface (e.g., Courier) of a particular size (e.g., 14 pt); the shadow format may thus be a shade of gray and the same typeface and font size as the focus format. However, the focus format may include any other suitable formatting contrasting more with the background than the shadow format.

As shown in FIG. 3, the second preferred method can further include block S250, which recites including displaying the second text line in the focus format. Block S250 preferably functions to present the second text line over the background and in a format readily distinguishable from the background and the shadow format. Block S250 is preferably implemented following initiation of the second text line, as indicated by fulfillment of the number of predetermined characters or words in the first text line or by completion of the sentence, paragraph, or list item of the first text line.

As shown in FIG. 3, the second preferred method can further include block S260, which recites including shifting the first text line to the shadow format, functions to reduce the contrast between the first text line and the background, as compared to the contrast between the present (e.g., second) text line and the background. Block S260 is preferably implemented following initiation of the second text line. Specifically, an alphanumeric character beginning the second text line preferably signals transition of the first text line from the focus format to the shadow format such that the second text line preferably thus assumes the focus format. The first text line is preferably displayed in the shadow format when the second text line is displayed in the focus format. Furthermore, the first and second text lines are preferably displayed in the shadow format when any other text line is displayed in the focus format. The focus and shadow formats may also define a portion of a format gradient in which the present text line is displayed in the focus format, a previous text line adjacent the present text line is displayed in a first shadow format of less contrast with the background than the focus format, and/or a second previous text line preceding and adjacent the previous text line is displayed in a second shadow format of less contrast with the background than the first shadow format.

As shown in FIG. 3, the second preferred method can further include block S270, which recites shifting the first text line to the focus format and the second text line to the shadow format given a scrolling input provided through a user interface device. Block S270 preferably functions to shift focus within the text editor based upon an input from the user. The user interface device may be a physical mouse, trackpad, keyboard, keypad, or touch display configured to provide a scrolling function, though the user interface device may be any other suitable device or implement. The user may navigate through the text editor by engaging a scrolling input of the user interface device. To ease such navigation, the text lines are preferably displayed in the focus format (or the shadow format) to provide equal weighting to each text line as the user navigates through the text document.

As shown in FIG. 3, the second preferred method can further include block S280, which recites receiving a cursor input pointing to a particular text line. Block S280 preferably functions to capture a user input pointing to the desired present text line. Preferably, the user may select the particular text line by inserting the text input caret within the particular text line, by selecting the text line, by selecting a formatting identifier character (e.g., a bullet), or by any other means.

As shown in FIG. 3, the second preferred method can further include block S290, which recites including shifting text lines other than the particular text line to the shadow format. Block S290 preferably functions to visually transition the text lines to depict the particular text line as the present text line. Once the particular text line is selected in Block S280, the particular text line preferably becomes the present text line and all other text lines preferably shift to the shadow format. Specifically, the focus and shadow formats of text lines within the text editor are preferably updated in Block S290 to reflect the location of the text input caret within the text editor as the user navigates through the text therein. This may aid the user in editing the text document by focusing the attention of the user on one (i.e. the particular) text line at any given time as the user navigates through the text.

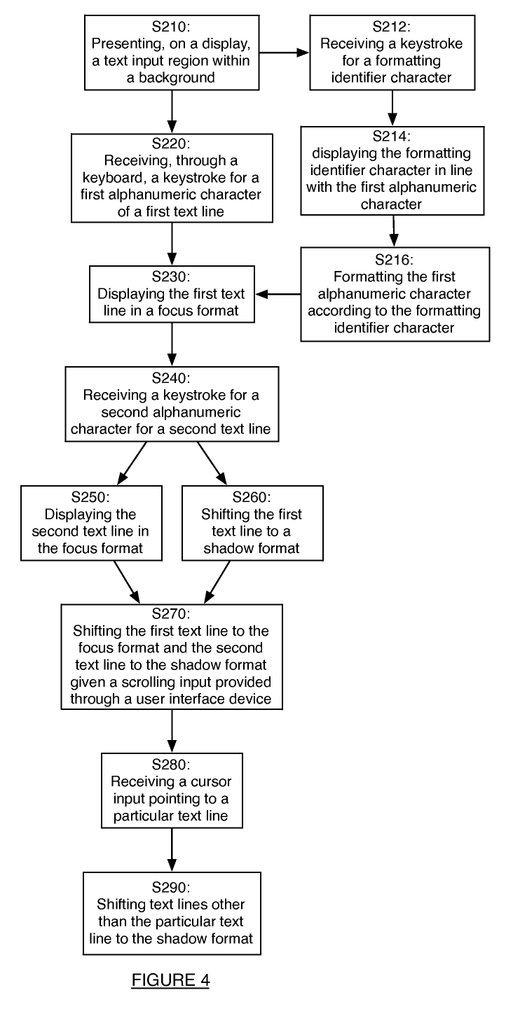

As shown in FIG. 4, one variation of the second preferred method can further include: receiving a keystroke for a formatting identifier character in block S212; displaying the formatting identifier character in line with the first alphanumeric character in block S214; and formatting the first alphanumeric character according to the formatting identifier character in block S216. Blocks S212, S214, and S216 preferably provide formatting functionality through character-based formatting symbols, which may yield reduced user distraction as core formatting functionality is provided through the same input means as text composition. Specifically, by formatting a portion of a text line based upon characters or symbols provided through keystrokes rather than based upon formatting selections provided through navigable menus or windows (i.e. with a mouse cursor), the user may add, remove, or modify formatting in the midst of composition and specifically without switching to a different input format (e.g., from a keyboard to a mouse).

As shown in FIG. 8B, the formatting identifier character is preferably displayed inline with the character, word, or text line that is modified. The formatting identifier character may be paired with a second formatting identifier character, and the formatting identifier character may indicate an indent, a heading hierarchy, a bulleted or numbered list, bold typeface, an underline, italics, a strikethrough, or any other suitable formatting.

### 3. The Third Preferred Method

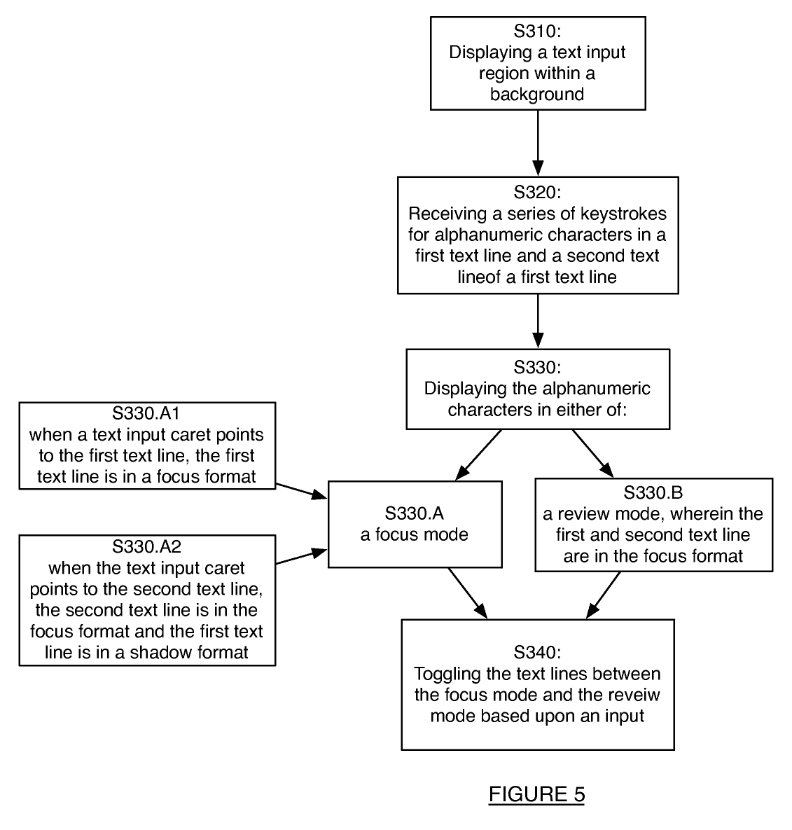

As shown in FIG. 5, a third preferred method S310 of displaying text in a text editor can include: displaying a text input region within background in block S310; receiving a series of keystrokes for alphanumeric characters in a first text line and a second text line in block S320; displaying the alphanumeric characters in either of a focus mode and a review mode in block S330; and toggling the text lines between the focus mode and the review mode based upon an input in block S340. Preferably, in the focus mode, when a text input caret points to the first text line, the first text line is in a focus format of a first contrast with the background in block S330.A1. Preferably when the text input caret points to the second text line, the second text line is in the focus format and the first text line is in a shadow format of a second contrast with the background less than the first contrast in block S330.A2. In the review mode, the first and second text lines are preferably, but not necessarily, in the same format. The third preferred method is preferably implemented through a digital text editor executing on an electronic device that includes a digital display, such as a laptop, desktop, or tablet computer, a smartphone, a PDA, or an e-book reader, or any other suitable device or system noted above.

As shown in FIG. 5, the third preferred method includes block S310, which recites displaying the text input region within the background. Block S310 preferably functions to define an area within a text editor interface in which keystrokes are displayed, on top of the background, in the form of alphanumeric characters. The background is preferably a plain, solid-color background within the text editor, such as a solid-white background, as shown in FIG. 6. However, the background may be of any other form, pattern, or color.

As shown in FIG. 5, the third preferred method can further include block S320, which recites receiving keystrokes for alphanumeric characters in the first text line and the second text line, functions to capture text inputs provided by the user. The alphanumeric characters may define the beginning or end of a text line or any character therebetween. The text lines can include any of: a string of characters of a predetermined length, a predetermined number of words, a sentence, a paragraph, or a list (or line) item. However, the text line may be of any other suitable semantic or grammatical form or format in any available or suitable language. The alphanumeric characters are preferably generated in response to user action on a user interface. A suitable user interface can include a standalone physical keyboard wired or wirelessly coupled to the electronic device, a physical keyboard integrated into the electronic device, or a keyboard or keypad displayed on a touchscreen of the electronic device.

As shown in FIG. 5, the third preferred method can further include block S330, which recites displaying the alphanumeric characters in either of the focus mode and the review mode. As shown, block S330 can include a focus mode in block S330A and a review mode in block S330B. In the focus mode, block S330A preferably functions to provide a reduced-distraction writing environment, wherein text lines are presented to a user in varying formats configured to focus the attention of the user on the present text line and reduce distraction caused by peripheral or adjacent text lines. In the review mode, S330.A2 preferably functions to display text lines in the text document with equal visual weighting.

In the focus mode, the present text line (i.e. the text line currently being composed, the text line currently being edited, or the text line currently including a text input caret) is given more visual weight in the text input region than other text lines. Preferably, in the focus mode S330.A1, the present text line is presented in the focus format to have greater contrast with the background than other text lines, which are presented in the shadow format. The focus format is preferably a typeface, font size, color, shading, or other text-appropriate formatting contrasting with the background substantially more than the shadow format. For example, in the variation in which the background is a plain white background, the focus format may be black, wherein the present text line is displayed over the background in black typeface (e.g., Courier) of a particular size (e.g., 14 pt); the shadow format may thus be a shade of gray and the same typeface and font size as the focus format. Additionally or alternatively the focus format may be bold typeface and the shadow format a normal typeface (as shown in FIG. 6). In another addition/alternative, the focus format may be a first font size and the shadow format a second font size less than the first font size. In another addition/alternative, the focus format may be a first typeface and the shadow format a second typeface. In another addition/alternative, the focus format may comprise underlining and the shadow format strikethroughs. In another addition/alternative, the focus format may include highlighting and the shadow format none, or vice versa. In still another addition/alternative, the focus format may include any other suitable formatting contrasting more with the background than the shadow format.

In the review mode S330.A2, all text lines, including the first and second text lines, are preferably displayed in the same format. In the review mode S330.A2, all text lines are preferably displayed in the focus format, but the text lines may alternatively be displayed in the shadow format, a review format, or a variation of the focus or shadow formats. For example, when the background is white (hex triplet #FFFFFF), the focus format is black (hex triplet #000000), and the shadow format is light gray (hex triplet #DCDCDC), the review format may be dim gray (hex triplet #696969). However, text lines may be displayed in any other format in the review mode S330.A2.

As shown in FIG. 5, the third preferred method can further include block S340, which recites toggling the text lines between the focus mode and the review mode based upon the input. Block S340 preferably functions to capture an input from the user and to shift visual depiction of the text lines according to the input. For example, the user may strike [CNTL]+[d] on the keyboard or keypad to switch between the focus and review modes. Alternatively, the user may use a mouse cursor to navigate to a menu within the text editor window to engage and disengage the modes, such as by selecting a radio button. However, any other action performed through any other device or implement may be captured in Block S340 to control a shift between the focus and review modes.

The preferred and all variations thereof are preferably applied to a digital text editor executing on an electronic device. However, the preferred methods may alternatively be applied to other editor fields. In a first example, the methods are applied to cooperative document editing, wherein each editor views a different text line in the focus format. In a second example, the methods are applied to code editors, wherein the focus and shadow formats are distributed according to currently edited functions. In a third example, the methods may be applied to desktop editing tools, mobile editing tools, or any suitable editing environment.

The methods of the preferred embodiments can be embodied and/or implemented at least in part as a machine configured to receive a computer-readable medium storing computer-readable instructions. The instructions are preferably executed by computer-executable components preferably integrated with the electronic device. Other methods of the preferred embodiments can be embodied and/or implemented at least in part as a machine configured to receive a computer-readable medium storing computer-readable instructions. The instructions are preferably executed by computer-executable components preferably integrated by computer-executable components preferably integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component is preferably a processor but any suitable dedicated hardware device can (alternatively or additionally) execute the instructions.

As a person skilled in the art will recognize from the previous detailed description and from the figures and claims, modifications and changes can be made to the preferred embodiments of the invention without departing from the scope of this invention defined in the following claims.

We claim:

1. A method of displaying text in a text editor, the method comprising:
displaying a text input region within a background;
receiving a keystroke for a first alphanumeric character of a first text line;
displaying the first text line in a focus format of a first contrast with the background;
receiving a keystroke for a second alphanumeric character of a second text line;
displaying the second text line in the focus format;
shifting the first text line to a shadow format of a second contrast with the background less than the first contrast when the second text line is displayed in the focus format; and
shifting the first text line to the focus format and the second text line to the shadow format when a text input caret shifts from the second text line to the first text line.

2. The method of claim 1, wherein the background is white, the focus format is black, and the shadow format is gray.

3. The method of claim 1, further comprising centering a particular text line vertically within the text input region when the text input caret points to the particular text line.

4. The method of claim 1, further comprising:
receiving a keystroke for a formatting identifier character;
displaying the formatting identifier character in line with the first alphanumeric character; and
formatting the first alphanumeric character according to the formatting identifier character.

5. The method of claim 4, wherein displaying the formatting character identifier and formatting the first alphanumeric character comprise:
displaying the formatting identifier character preceding the first alphanumeric character in the first text line;
displaying a second formatting identifier character succeeding the first alphanumeric character; and
formatting alphanumeric characters between the formatting identifier character and the second formatting identifier character according to the formatting identifier characters.

6. The method of claim 1, further comprising shifting the first and second text lines to the focus format given a scrolling input.

7. The method of claim 1, further comprising determining the second alphanumeric character to indicate the beginning of the second text line when the second alphanumeric character is preceded by a keystroke for a sentence completion punctuation character and a keystroke for a space character.

8. The method of claim 1, wherein the text line is selected from the group consisting of:
a string of characters of a predetermined length, a sentence, a paragraph, and a list item.

9. A method of displaying text in a text editor, the method comprising:
presenting, on a display, a text input region within a background;
receiving, through a keyboard coupled to the display, a keystroke for a first alphanumeric character of a first text line;
displaying the first text line in a focus format of a first contrast with the background;
receiving a keystroke for a second alphanumeric character of a second text line;
displaying the second text line in the focus format;
shifting the first text line to a shadow format of a second contrast with the background less than the first contrast when the second text line is displayed in the focus format;
shifting the first and second text lines to the focus format given a scrolling input provided through a user interface device coupled to the display;
receiving a cursor input, through the user interface device, pointing to a particular text line; and
shifting text lines other than the particular text line to the shadow format.

10. The method of claim 9, wherein the background is white, the focus format is black, and the shadow format is gray.

11. method of claim 9, further comprising:
receiving a keystroke for a formatting identifier character;
displaying the formatting identifier character in line with the first alphanumeric character; and
formatting the first alphanumeric character according to the formatting identifier character.

12. A method of displaying text in a text editor, the method comprising:
displaying a text input region within background;
receiving a series of keystrokes for alphanumeric characters in a first text line and a second text line;
displaying the alphanumeric characters in either of:
a focus mode, wherein, when a text input caret points to the first text line, the first text line is in a focus format of a first contrast with the background, and wherein, when the text input caret points to the second text line, the second text line is in the focus format and the first text line is in a shadow format of a second contrast with the background less than the first contrast; and
a review mode, wherein the first and second text lines are in the same format; and
toggling the text lines between the focus mode and the review mode based upon an input.

13. The method of claim 12, wherein the background is white, the focus format is black, and the shadow format is gray.

14. The method of claim 12, wherein the text line is selected from the group consisting of: a string of characters of a predetermined length, a sentence, a paragraph, and a list item.
